(19) United States
(12) Patent Application Publication
(10) Pub. No.: US 2010/0295392 A1
(43) Pub. Date: Nov. 25, 2010

(54) MOTOR

(75) Inventor: Shinichi Utsumi, Nagano (JP)

Correspondence Address: CANTOR COLBURN LLP, 20 Church Street, 22nd Floor, Hartford, CT, 06103, US

(73) Assignee: NIDEC SANKYO CORPORATION, Nagano (JP)

(21) Appl. No.: 12/376,948

(22) PCT Filed: Jul. 26, 2007
(86) PCT No.: PCT/JP2007/000798

§ 371 Date: Aug. 6, 2010

(30) Foreign Application Priority Data
Aug. 7, 2006 (JP) 2006-214986
Aug. 7, 2006 (JP) 2006-215013
Aug. 7, 2006 (JP) 2006-215014
Aug. 7, 2006 (JP) 2006-215015

(51) Int. Cl. H02K 3/28; H02K 5/22; H02K 5/16; H02K 1/12

(52) U.S. Cl. 310/71; 310/90; 310/257

(57) ABSTRACT

Provided is a motor which is thinned by improving the structure of a section for feeding a driving coil with power. In a motor, a stator is provided with substrate holding sections for holding a power feeding substrate in substantially vertical posture to a motor shaft line direction. On the power feeding substrate, land sections, to which coil terminals of driving coils are connected, are formed. Thus, a terminal block is not required, and a structure for firmly fixing a terminal pin to the terminal block for processing the coil terminal is not required.

### CROSS REFERENCE TO RELATED APPLICATION

This is a U.S. national stage of application No. PCT/JP2007/000798, filed on Jul. 26, 2007. Priority under 35 U.S.C. §119(a) and 35 U.S.C. §365(b) is claimed from Japanese Application No. 2006-214986, filed Aug. 7, 2006; Japanese Application No. 2006-215013, filed Aug. 7, 2006; Japanese Application No. 2006-215014, filed Aug. 7, 2006; and Japanese Application No. 2006-215015, filed Aug. 7, 2006; the disclosures of each of which are also incorporated herein by reference.

### FIELD OF THE INVENTION

The present invention relates to a structure of a motor. More specifically, the present invention relates to a structure for supplying electrical power to a drive coil, a bearing structure for a rotation shaft, a structure of a drive coil and a structure of power supply to the drive coil, and a structure of a stator.

### BACKGROUND

For a structure of a motor in which coil ends of a drive coil are connected to the outside, a structure has been proposed in which a coil end is bound to a terminal that is press-fitted to or integrally formed in a resin bobbin and the terminal is connected to the outside (see, for example, Patent Reference 1).

Further, for a bearing mechanism of a motor, a structure has been known in which a radial bearing for supporting a rotation shaft in a radial direction and a thrust bearing for supporting the rotation shaft in a thrust direction are separately provided. For example, a structure has been proposed in which a ball bearing is provided for a rotation shaft to support the rotation shaft in a radial direction and a thrust direction (see, for example, Patent Reference 2).

Further, for a structure of a drive coil which is used in a stator, a structure has been proposed in which an air-core coil (bobbin-less coil) is used which is structured of a coil wire that is comprised of a round wire and is wound around in a ring shape and in a multi-layer manner. A winding end coil of the air-core coil is drawn out from an outer peripheral part of the air-core coil and a winding start coil is drawn out from an inner peripheral part of the air-core coil (see, for example, Patent Reference 3).

Further, a stepping motor commonly includes a rotor provided with a permanent magnet and a stator disposed on an outer peripheral side of the rotor. Further, an “A”-phase stator assembly and a “B”-phase stator assembly in the stator are respectively provided with an inner stator core and an outer stator core, and first pole teeth protruded from a first end plate part of the inner stator core and second pole teeth protruded from a second end plate part of the outer stator core are alternately and adjacently arranged in a circumferential direction. While the first pole teeth and the second pole teeth are ordinarily formed in the same dimension as each other, the first pole teeth may be set shorter than the second pole teeth. For example, a structure of a stator has been proposed in which, since root portions of the outer stator core do not face a permanent magnet of a rotor, second pole teeth protruded from an end plate part of an outer stator core are set to be longer than first pole teeth protruded from an end plate part of an inner stator core (see, for example, Patent Reference 4).

[Patent Reference 1] Japanese Patent Laid-Open No. 2005-33920

[Patent Reference 2] Japanese Patent Laid-Open No. Hei 7-107731

[Patent Reference 3] Japanese Utility Model Laid-Open No. Hei 6-60263

[Patent Reference 4] Japanese Patent Laid-Open No. 2005-269863

### SUMMARY OF THE INVENTION

However, in the above-mentioned conventional structure where the coil ends of the drive coil are connected to the outside, when the resin bobbin integrally formed with the terminal is disposed in a motor as a member for connecting to the outside, a thickness of the motor is increased by a thickness of the bobbin and thus it is difficult to reduce the thickness of the motor.

Further, in a conventional motor having a bearing mechanism in which a radial bearing and a thrust bearing are disposed separately, since the radial bearing and the thrust bearing are disposed separately in the axial direction, it is difficult to reduce a height and a size of the motor. Further, when the ball bearing which is disclosed in the Patent Reference 2 is used, since the bearing itself is large, it is difficult to reduce a height and a size of the motor and the structure becomes to be complicated and expensive.

Further, in the conventional structure of the drive coil, the winding start coil is overlapped on an end face of the air-core coil and thus the drive coil becomes thicker by a wire diameter of the winding start coil to cause to be unable to reduce the height of the motor. Further, when the winding start coil is overlapped on the end face of the air-core coil, at the time of assembling the drive coil into the motor, an excessive force may be easily applied to the drive coil or the winding start coil to cause disconnection to occur. Therefore, a member for preventing disconnection is required and, as a result, the structure of the motor becomes complicated and it is difficult to make the motor thinner. In addition, the winding start coil and the winding end coil are connected to the terminals fixed to the resin bobbin having a large wall thickness and thus it is difficult to make the motor thinner.

Further, like the structure of the conventional stator, the structure in which the first pole teeth formed in one of the stator cores are formed shorter than the second pole teeth formed in the other stator core may be utilized as a countermeasure for restraining leakage flux between the first pole teeth and the second end plate part of the other stator core when the first pole teeth are located to be close to the second end plate part of the other stator core. However, in order to restrain the leakage flux, the first pole teeth are required to be considerably shorter and, as a result, a sufficient magnetic field is not formed and a torque is decreased.

In view of the problems described above, a first objective of the present invention is to provide a motor in which a structure of a power supply part to a drive coil is improved so as to be capable of making the motor thinner.

Further, a second objective of the present invention is to provide a motor in which a bearing structure is improved so as to be capable of making the motor thinner.

Further, a third objective of the present invention is to provide a motor in which a structure of a drive coil and a power supply structure to the drive coil are improved so as to be capable of making the motor thinner.

Further, a fourth objective of the present invention is to provide a motor in which a shape of pole teeth is improved so as to be capable of obtaining a large torque.

In order to attain the first objective, according to at least an embodiment of the present invention, there is provided a motor including a rotor provided with a permanent magnet, and a stator which is provided with stator cores and a drive coil and which is disposed on an outer peripheral side of the rotor. The stator is provided with a circuit board holding part for holding a circuit board for power supply in a posture which is substantially perpendicular to an axial line direction of the motor, and the circuit board for power supply is formed with land parts with which coil ends of the drive coil are connected.

In accordance with this invention, the circuit board for power supply is held in a posture which is substantially perpendicular to the axial line direction of the motor and coil ends of the drive coil are connected to the circuit board for power supply. Therefore, a resin bobbin in which terminals are integrally formed is not required. Further, since the circuit board for power supply is held by the circuit board holding part of the stator, a separate member for holding the circuit board for power supply is not required. Therefore, the structure of the motor can be simplified. In addition, the circuit board for power supply which is held in a posture which is substantially perpendicular to the axial line direction of the motor is thinner than a resin bobbin in which terminals are integrally formed and thus the motor can be made thinner.

In at least an embodiment of the present invention, it is preferable that the stator includes an “A”-phase stator assembly and a “B”-phase stator assembly which are superposed on each other in a thrust direction and disposed around the rotor, and each of the “A”-phase stator assembly and the “B”-phase stator assembly is provided as the stator core with an inner stator core and an outer stator core on both sides in the thrust direction of the drive coil, and the inner stator cores are superposed on each other in the thrust direction, and the circuit board holding part includes a first protruded part which is protruded on an outer side in a radial direction from the inner stator core of the “A”-phase stator assembly and a second protruded part which is protruded on an outer side in the radial direction from the inner stator core of the “B”-phase stator assembly so that the circuit board for power supply is sandwiched between the first protruded part and the second protruded part. According to this structure, the circuit board for power supply can be easily held in the posture which is substantially perpendicular to the axial line direction of the motor, and the circuit board for power supply is located between the “A”-phase stator assembly and the “B”-phase stator assembly. Therefore, it is convenient to treat the coil ends of the respective drive coils which are used in the “A”-phase stator assembly and the “B”-phase stator assembly. Further, a protruded part is easily formed in the inner stator core and thus a die which is used to manufacture the inner stator core by press working can be easily formed by means of that a shape of the die is partly modified.

In at least an embodiment of the present invention, it is preferable that the circuit board for power supply is provided with, as the land part, a land part formed on one side face of the circuit board for power supply for being connected with a coil end of a drive coil of the “A”-phase stator assembly, and a land part formed on the other side face of the circuit board for power supply for being connected with a coil end of a drive coil of the “B”-phase stator assembly. According to this structure, it is convenient to treat the coil ends of the respective drive coils which are used in the “A”-phase stator assembly and the “B”-phase stator assembly.

In at least an embodiment of the present invention, it is preferable that each of the first protruded part and the second protruded part includes at least two protruded parts so as to be capable of holding both end portions of the circuit board for power supply. According to this structure, the circuit board for power supply can be held in a stable state.

In at least an embodiment of the present invention, it is preferable that the first protruded part includes a base part which is horizontally extended on the outer side in the radial direction from a ring portion of the inner stator core of the “A”-phase stator assembly, a bent part which is bent downward from a tip end of the base part, and a horizontal plate part which is horizontally extended on the outer side in radial direction from the bent part, and the second protruded part includes a base part which is horizontally extended on the outer side in the radial direction from a ring portion of the inner stator core of the “B”-phase stator assembly, a bent part which is bent upward from a tip end of the base part, and a horizontal plate part which is horizontally extended on the outer side in the radial direction from the bent part. According to this structure, the horizontal plate parts on the tip end sides are extended with positions separated from each other through the bent parts in the first protruded part and the second protruded part to form a space corresponding to a thickness of the circuit board for power supply between the horizontal plate parts and thus the circuit board for power supply can be held in the space. As a result, the circuit board for power supply can be held on outer peripheral sides of the first inner stator core and the second inner stator core in the posture substantially perpendicular to the motor axis line.

In at least an embodiment of the present invention, it is preferable that the circuit board for power supply includes a main body portion on which the land part is formed and connection parts which are protruded from both end portions of the main body part for being sandwiched by the first protruded part and the second protruded part, and the circuit board for power supply is connected with a flexible circuit board which is disposed substantially perpendicular to the circuit board for power supply, and a rear face of the flexible circuit board is positioned by abutting with the connection part or the first protruded part and the second protruded part. According to this structure, the flexible circuit board can be surely disposed at a predetermined position with respect to the circuit board for power supply and thus an electrical connection between the circuit board for power supply and the flexible circuit board can be easily attained.

In at least an embodiment of the present invention, it is preferable that an end part on an outer peripheral side of the connection part of the circuit board for power supply is located on an inner side with respect to an end part on an outer peripheral side of the main body part, and a portion of the main body portion which is protruded toward an outer peripheral side from the flexible circuit board is electrically connect with the flexible circuit board. According to this structure, an electrical connection between the circuit board for power supply and the flexible circuit board can be performed on the outside of the flexible circuit board and thus connecting work is easily performed.

In order to attain the second objective, according to at least an embodiment of the present invention, there is provided a motor including a rotor provided with a rotation shaft and a permanent magnet, a stator which is disposed on an outer peripheral side so as to face the permanent magnet, a first bearing which is fixed to one end face of the stator for rotatably supporting the rotation shaft, and a second bearing which is fixed to an other end face of the stator for rotatably supporting the rotation shaft. The first bearing and the second bearing are provided with a radial support part for supporting an outer peripheral face of the rotation shaft, and at least one of the first bearing and the second bearing is provided with a thrust support part for supporting the rotor in a thrust direction on an inner side where the other of the first bearing and the second bearing is located.

In accordance with this invention, at least one of the first bearing and the second bearing is provided with a radial support part and a thrust support part and thus one piece of bearing is provided with both of a function for supporting the rotor in the radial direction and a function for supporting in the thrust direction. Therefore, the number of part items are reduced and the size and the width or the height of the motor can be reduced. Further, the radial support part supports the outer peripheral face of the rotation shaft and the thrust support part supports a portion of the rotor except the shaft end of the rotation shaft. Therefore, neither of the radial support part and the thrust support part are disposed on an outer side in the thrust direction of the shaft end of the rotation shaft. Therefore, the motor can be made thinner.

In at least an embodiment of the present invention, it is preferable that the first bearing is provided with the radial support part and the thrust support part, and the second bearing is provided with the radial support part and a stopper part which is formed on an inner face side where the first bearing is located, and which is capable of determining a moving range in the thrust direction of the rotor through a predetermined gap space in the thrust direction. According to this structure, one piece of the second bearing is provided with both of a function for supporting the rotor in the radial direction and a function for preventing an excessive movement of the rotor in the thrust direction. Therefore, the number of part items are reduced and the size and the width or the height of the motor can be reduced. Further, even when the stopper part is provided in the second bearing, the stopper part faces the portion of the rotor except the shaft end of the rotation shaft and thus the stopper part is not required to be disposed on an outer side of the shaft end of the rotation shaft in the thrust direction. Therefore, it is suitable to make the motor thinner.

In at least an embodiment of the present invention, it may be structured that the rotor is structured so that the permanent magnet is integrated with the rotation shaft through a rotor case, and the thrust support part is contacted with the rotor case in the thrust direction, and the stopper part faces the rotor case through a predetermined gap space in the thrust direction.

In at least an embodiment of the present invention, it is preferable that the rotor case includes an inner peripheral side cylindrical part into which the rotation shaft is fitted, an outer peripheral side cylindrical part whose outer peripheral face is fixed to the permanent magnet, and a ring-shaped flat plate part which connects the inner peripheral side cylindrical part with the outer peripheral side cylindrical part, and the thrust support part is contacted with the ring-shaped flat plate part in the thrust direction, and the stopper part faces the ring-shaped flat plate part through a predetermined gap space in the thrust direction. According to this structure, a sliding portion of the rotor with the thrust support part is the ring-shaped flat plate part so as to be in a face contact state and thus abrasion hardly occurs and a long lifetime of the motor can be attained. Further, even when the stopper part is abutted with the rotor during rotation, different from a case that the stopper part is abutted with a tip end part of the inner peripheral side cylindrical part or a tip end part of the outer peripheral side cylindrical part, an excessive impact is not applied to the second bearing and the rotor. Therefore, damage does not occur in the second bearing and the rotor, and abrasion also does not occur and thus the lifetime of the motor can be extended. In addition, when the rotor case is formed by drawing working, although a high productivity is obtained, a burr is easily formed at the tip end part of the inner peripheral side cylindrical part. However, since the portion other than the inner peripheral side cylindrical part is abutted with the stopper part, even when a burr is formed at the tip end part of inner peripheral side cylindrical part, the second bearing is not caught by the rotor.

In at least an embodiment of the present invention, it is preferable that the permanent magnet is disposed on an outer side in the radial direction with respect to both of the first bearing and the second bearing. According to this structure, even when the first bearing and the second bearing are protruded on the inner side in the thrust direction, a large magnet in the thrust direction (width dimension) may be used for the permanent magnet. Accordingly, even when the motor is made thinner, a large output can be obtained.

In order to attain the third objective, according to an embodiment of the present invention, there is provided a motor including a rotor provided with a permanent magnet, and a stator which is provided with stator cores and a drive coil and which is disposed on an outer peripheral side of the rotor. The drive coil is a coil which is structured by means of that a coil wire is wound around in an alpha winding manner and in which a pair of coil ends is located at an outer peripheral part, and the pair of the coil ends are connected with a common circuit board for power supply.

According to at least an embodiment of the present invention, since a coil made by alpha winding is used for the drive coil, both of a pair of coil ends are located at the outer peripheral part of the drive coil. Therefore, when the coil ends are connected to the circuit board for power supply, neither of the pair of the coil ends are overlapped on an end face of the drive coil and thus the drive coil is thin. Further, since the coil ends do not overlap the end face of the drive coil, when the drive coil is to be mounted on the motor, an unfavorable force is not applied to the drive coil or the coil ends and thus disconnection does not occur and a member for preventing disconnection is not required. Accordingly, the structure of the motor can be simplified and the motor can be made thinner. Further, since the coil ends are connected with the circuit board for power supply, a thick resin bobbin in which that terminals are integrally formed is not required. Therefore, the motor can be made thinner. In an embodiment of the present invention, the drive coil made by alpha winding is obtained by means of that, after a midway portion of a coil wire is wound around an outer peripheral face of a jig formed in a tubular shape or in a cylindrical shape, one of end parts is wound around the jig in a multi-layer and the other of the end parts is wound around at an adjacent portion in a multi-layer.

In an embodiment of the present invention, it is preferable that the circuit board for power supply is disposed on a side of the stator so as to be substantially perpendicular to an axial line direction of the motor. According to this structure, since the circuit board for power supply does not affect a thickness dimension of the motor, the motor can be made thinner and soldering of the coil end with the land part on the circuit board for power supply and the like can be easily performed.

In an embodiment of the present invention, it is preferable that the pair of the coil ends are wound around to a near position where the pair of the coil ends are separated from each other with a distance shorter than a length dimension of the circuit board for power supply at an outer peripheral part of the drive coil, and the pair of the coil ends are bent at the near position to be drawn out toward an outer side in the radial direction. According to this structure, the coil end can be guided to the circuit board for power supply without drawing around and soldering of the coil end with the land part on the circuit board for power supply and the like can be easily performed.

In an embodiment of the present invention, it is preferable that the pair of the coil ends are extended along a circuit board face of the circuit board for power supply. According to this structure, soldering of the coil end with the land part on the circuit board for power supply and the like can be easily performed.

In an embodiment of the present invention, it is preferable that the pair of the coil ends are extended from the drive coil so as to contact with the circuit board face of the circuit board for power supply. According to this structure, soldering of the coil end with the land part on the circuit board for power supply and the like can be easily performed.

In an embodiment of the present invention, it is preferable that the stator core comprises an inner stator core and an outer stator core which are disposed on both sides in a thrust direction of the drive coil, and the drive coil is provided with insulation sheets on both sides in the thrust direction. According to this structure, since insulation of the drive coil is secured through the insulation sheets from the inner stator core and the outer stator core, the insulation can be secured without using a conventional resin bobbin. Further, since no resin bobbin is used, the size and the width or the height of the motor can be reduced.

In an embodiment of the present invention, it is preferable that the stator includes an “A”-phase stator assembly and a “B”-phase stator assembly which are superposed on each other in the thrust direction, and each of the “A”-phase stator assembly and the “B”-phase stator assembly is provided as the stator core with an inner stator core and an outer stator core on both sides in the thrust direction of the drive coil, and the inner stator cores are superposed on each other in the thrust direction, both of coil ends drawn out from the drive coil of the “A”-phase stator assembly and coil ends drawn out from the drive coil of the “B”-phase stator assembly are connected to the circuit board for power supply that is used in common. According to this structure, only one piece of the circuit board for power supply is required.

In this case, it is preferable that one face side of the circuit board for power supply is provided with a land part with which the coil end of the drive coil of the “A”-phase stator assembly is connected, and the other face side of the circuit board for power supply is provided with a land part with which the coil end of the drive coil of the “B”-phase stator assembly is connected. According to this structure, it is convenient to treat the coil ends of the respective drive coils which are used in the “A”-phase stator assembly and the “B”-phase stator assembly.

In an embodiment of the present invention, it is preferable that each of the drive coil of the “A”-phase stator assembly and the “B”-phase stator assembly is provided with insulation sheets on both sides in the thrust direction, and the insulation sheets are disposed so as to be superposed on the inner stator core and the outer stator core of the respective stator cores of the “A”-phase stator assembly and the “B”-phase stator assembly. According to this structure, since insulation of the drive coil to the inner stator core and the outer stator core is secured by the insulation sheets, the insulation can be secured without using a conventional resin bobbin. Further, since no resin bobbin is used, the size and the width or the height of the motor can be further reduced.

In order to attain the fourth objective, according to an embodiment of the present invention, there is provided a motor including a rotor provided with a permanent magnet, and a stator which is disposed on an outer peripheral side of the rotor. The stator includes a pair of stator cores which are disposed so as to face each other, and first pole teeth which are protruded from a first end plate part of one of the stator cores and second pole teeth which are protruded from a second end plate part of the other of the stator cores are alternately disposed in a circumferential direction, and a pole tooth of the first pole teeth is formed with a recessed part at a center position in a widthwise direction of a tip end part of the pole tooth.

According to at least an embodiment of the present invention, a facing distance between one of the stator cores and the other of the stator cores is shortened in order to make the motor thinner, the first pole teeth which are formed in one of the stator cores are disposed to be close to the end plate part of the other of the stator cores (the second end plate part). However, the first pole teeth are formed with the recessed part which is formed at the center position in the widthwise direction of the tip end part and thus leakage of magnetic flux from the tip end part of the first pole teeth can be prevented. Accordingly, the magnetic flux flowing between the adjacent pole teeth is increased by the amount of flux which is prevented from leaking from the tip end parts of the first pole teeth and thus a large torque can be obtained.

According to at least an embodiment of the present invention, lengths of the first pole teeth are set to be shorter than lengths of the second pole teeth. According to this structure, leakage flux between the first pole teeth and the second end plate part can be restrained. Further, since the facing distance between one of the stator cores and the other of the stator cores can be shortened, the motor can be made thinner by the shortened amount.

In an embodiment of the present invention, it may be structured that the one of the stator cores is formed with a cut-out part between the first pole teeth, and the other of the stator cores is formed with the second end plate part between the second pole teeth.

In this case, it may be structured that tip end parts of the second pole teeth are located in the cut-out parts of the one of the stator cores, and tip end parts of the first pole teeth face the second end plate part in the thrust direction.

In an embodiment of the present invention, it may be structured that the stator includes an “A”-phase stator assembly and a “B”-phase stator assembly which are superposed on each other in the thrust direction, and each of the “A”-phase stator assembly and the “B”-phase stator assembly is provided as the stator core with an inner stator core and an outer stator core on both sides in the thrust direction of the drive coil, and the inner stator cores are superposed on each other in the thrust direction.

In an embodiment of the present invention, it is further preferable that the first pole teeth are formed in each of the inner stator cores of the “A”-phase stator assembly and the “B”-phase stator assembly, and the second pole teeth are formed in each of the outer stator cores of the “A”-phase stator assembly and the “B”-phase stator assembly.

In order to attain the first objective, according to an embodiment of the present invention, the coil ends of the drive coil are connected to the circuit board for power supply which is held in a posture which is substantially perpendicular to the axial line direction of the motor and thus a resin bobbin in which terminals are integrally formed is not required. Further, since the circuit board for power supply is held by the circuit board holding part of the stator, a separate member for holding the circuit board for power supply is not required. Therefore, the structure of the motor can be simplified. In addition, when the circuit board for power supply is held in a posture which is substantially perpendicular to the axial line direction of the motor, the circuit board is thinner than a resin bobbin in which terminals are integrally formed and thus the motor can be made thinner.

Further, in order to attain the second objective, according to an embodiment of the present invention, one piece of bearing is provided with both of a function for supporting the rotor in the radial direction and a function for supporting in the thrust direction. Therefore, the number of part items are reduced and the size and the width or the height of the motor can be reduced. Further, the radial support part supports the outer peripheral face of the rotation shaft and the thrust support part supports a portion of the rotor except the shaft end of the rotation shaft. Therefore, neither of the radial support part and the thrust support part are disposed on an outer side in the thrust direction of the shaft end of the rotation shaft. Therefore, the motor can be made thinner. Further, when one piece of the second bearing is provided with both of a function for supporting the rotor in the radial direction and a function for preventing an excessive movement of the rotor in the thrust direction, the number of part items are reduced and the size and the width or the height of the motor can be reduced. Further, even when the stopper part is provided in the second bearing, the stopper part faces the portion of the rotor except the shaft end of the rotation shaft and thus the stopper part is not required to be disposed on an outer side of the shaft end of the rotation shaft in the thrust direction. Therefore, it is suitable to make the motor thinner.

In addition, in order to attain the third objective, according to an embodiment of the present invention, since an air-core coil made by alpha winding is used for the drive coil, both of a pair of coil ends are located at the outer peripheral part of the air-core coil. Therefore, when the coil ends are connected to the circuit board for power supply, neither of the pair of the coil ends are overlapped on an end face of the air-core coil and thus the drive coil is thin. Further, since the coil ends do not overlap the end face of the air-core coil, when the drive coil is to be mounted on the motor, an unfavorable force is not applied to the drive coil or the coil ends and thus disconnection does not occur and a member for preventing disconnection is not required. Accordingly, the structure of the motor can be simplified and the motor can be made thinner. Further, since the coil ends are connected with the circuit board for power supply, a thick resin bobbin in which that terminals are integrally formed is not required and thus the motor can be made thinner.

In addition, in order to attain the fourth objective, according to an embodiment of the present invention, a facing distance between one of the stator cores and the other of the stator cores is shortened in order to make the motor thinner, the first pole teeth which are formed in one of the stator cores are disposed to be close to the second end plate part of the other of the stator cores. However, the first pole teeth are formed with the recessed part which is formed at the center position in the widthwise direction of the tip end part and thus leakage of magnetic flux from the tip end part of the first pole teeth can be prevented. Accordingly, the magnetic flux flowing between the adjacent pole teeth is increased by the amount of flux which is prevented from leaking from the tip end parts of the first pole teeth and thus a large torque can be obtained.

### BRIEF DESCRIPTION OF THE DRAWINGS

Embodiment will now be described, by way of example only, with reference to the accompanying drawings which are meant to be exemplary, not limiting, and wherein like elements are numbered alike in several Figures, in which:

FIG. 1 is an explanatory view showing a planar structure of a motor to which an embodiment of the present invention is applied.

FIG. 2 is an “A-A′” cross-sectional view in FIG. 1.

FIG. 3 is an exploded perspective view showing the motor shown in FIG. 1.

FIGS. 4(A) and 4(B) are explanatory views showing a drive coil which is provided in the motor shown in FIG. 1.

FIGS. 5(A) through 5(D) are explanatory views showing a stator which is provided in the motor shown in FIG. 1.

FIGS. 6(A), 6(B) and 6(C) are explanatory views showing pole teeth which are provided in the motor shown in FIG. 1.

### DETAILED DESCRIPTION OF PREFERRED EMBODIMENTS

A motor to which an embodiment of the present invention is applied will be described below with reference to the accompanying drawings.

### (Entire Structure of Motor)

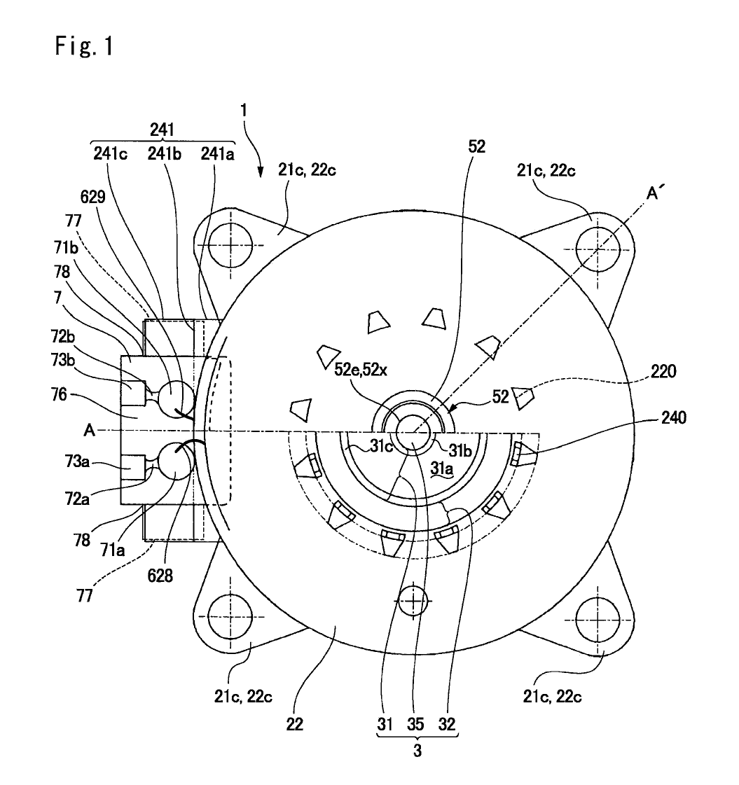

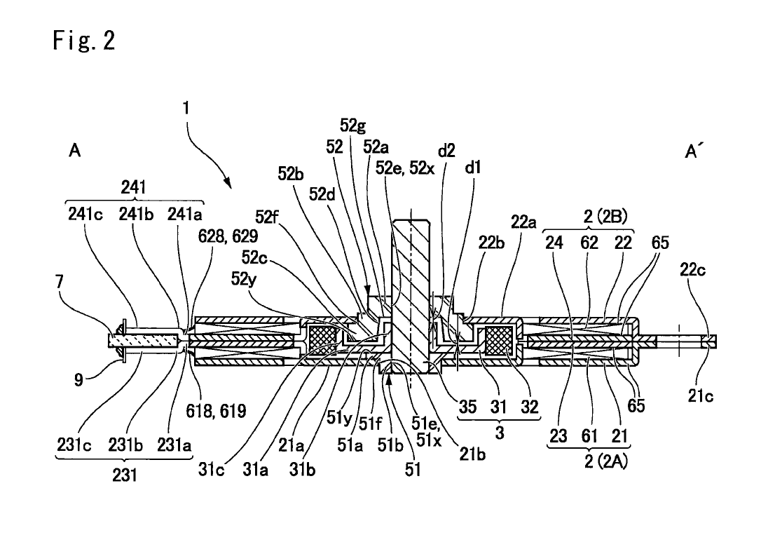

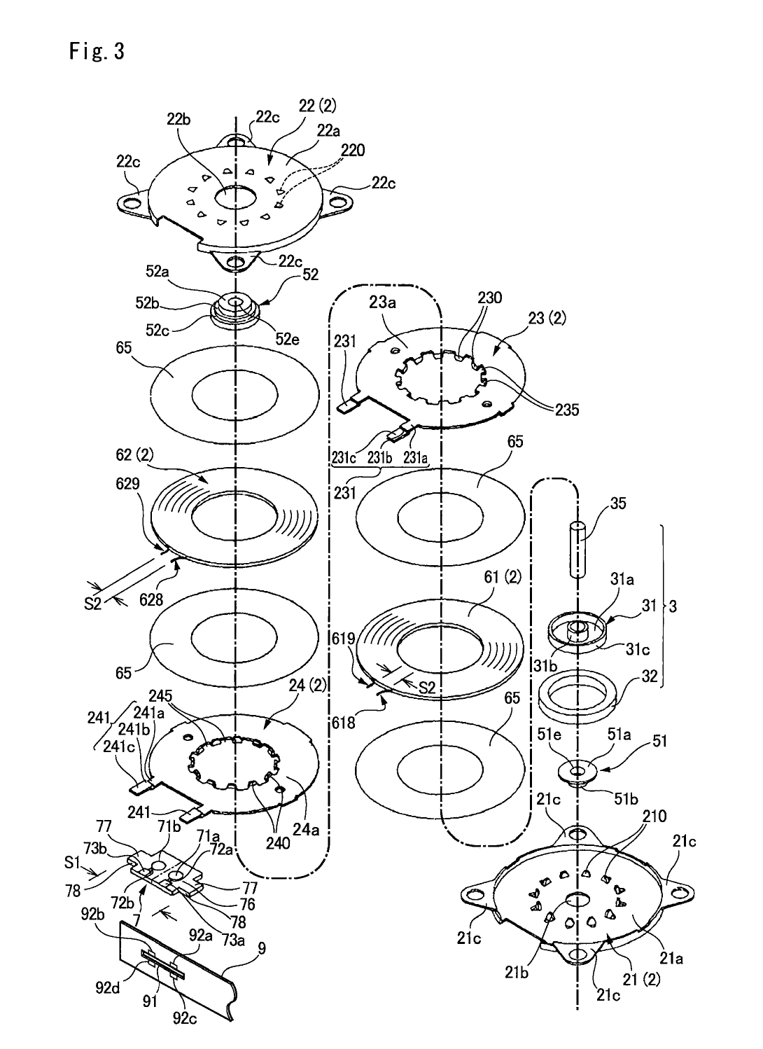

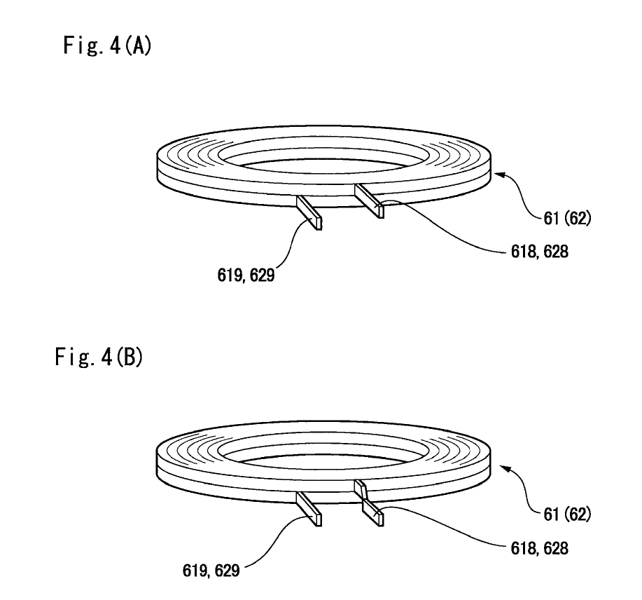

FIG. 1 is an explanatory view showing a planar structure of a motor to which an embodiment of the present invention is applied, and FIG. 2 is an “A-A” cross-sectional view in FIG. 1. An upper half portion in FIG. 1 shows an upper case of the motor which is viewed from an output side and a lower half portion in FIG. 1 shows a planar structure of a rotor and the like which are disposed in the inside of the upper case. FIG. 3 is an exploded perspective view showing a motor to which an embodiment of the present invention is applied. FIGS. 4(A) and 4(B) are explanatory views showing a drive coil which is provided in a motor to which an embodiment of the present invention is applied.

A motor 1 shown in FIGS. 1, 2 and 3 is a stepping motor whose planar shape is circular. The motor 1 generally includes a first outer stator core 21 (the other of stator cores), a rotor 3, a first drive coil 61, a first inner stator core 23 (one of the stator cores), a second inner stator core 24 (one of the stator cores), a second drive coil 62 and a second outer stator core 22 (the other of the stator cores), which are superposed on each other in this order. The first outer stator core 21 and the second outer stator core 22 structure a stator 2 together with the first drive coil 61, the first inner stator core 23, the second inner stator core 24 and the second drive coil 62. The first outer stator core 21 and the second outer stator core 22 are also used as a lower case and an upper case. The motor 1 in this embodiment is not provided with a resin bobbin made of insulator, and a structure is utilized in which the first drive coil 61 and the second drive coil are superposed on the first outer stator core 21 and the second outer stator core through an insulation sheet 65 and thus the motor 1 is a so-called bobbin-less type motor.

### (Structure of Stator)

The first outer stator core 21 is a component part which is structured by means of that a rolled steel plate having thickness about 0.15 mm is press-worked in a bottomed cylindrical shape. A through hole 21b is formed at a center of a lower bottom part 21a (second end plate part) for holding an opposite-to-output side bearing 51 (first bearing). Further, a plurality of pole teeth 210 (second pole teeth) is cut and bent upward with an equal angular interval around the through hole 21b in the lower bottom part 21a of the first outer stator core 21. Further, the first outer stator core 21 is formed at equal angular positions with four joining parts 21c, which are formed to be bent on an outer side from an aperture edge of a drum part that is formed bent from the lower bottom part 21a.

The second outer stator core 22 is, similarly to the first outer stator core 21, a component part which is structured by means of that a rolled steel plate having thickness about 0.15 mm is press-worked in a bottomed cylindrical shape. A through hole 22b is formed at a center of an upper bottom part 22a (second end plate part) for holding an output side bearing 52 (second bearing). Further, a plurality of pole teeth 220 (second pole teeth) is cut and bent downward with an equal angular interval around the through hole 22b in the upper bottom part 21a of the second outer stator core 22. Further, the second outer stator core 22 is formed at equal angular positions with four joining parts 22c, which are formed to be bent on an outer side from an aperture edge of a drum part that is formed bent from the upper bottom part 22a. These joining parts 22c are formed at positions so as to overlap the joining parts 21c of the first outer stator core 21.

The first inner stator core 23 is a component part which is structured by means of that a rolled steel plate having thickness about 0.15 mm is press-worked in a ring shape. The first inner stator core 23 includes a plurality of pole teeth 230 (first pole teeth), which are bent downward at positions with an equal angular interval from an inner circumferential edge of a ring-shaped flange part 23a (first end plate part), cut-out parts 235 formed between a plurality of the respective pole teeth 230, and two protruded parts 231 (first protruded part) which are protruded in parallel from its outer peripheral edge. These protruded parts 231 respectively include base parts 231a, which are horizontally extended toward an outer side in a radial direction from a ring portion of the first inner stator core 23, bent parts 231b which are bent downward from tip ends of the base parts 231a, and horizontal plate parts 231c which are horizontally extended toward the outer side in the radial direction from the bent parts 231b. The protruded part 231 functions as a circuit board holding part for holding a circuit board 7 for power supply which will be described below.

The second inner stator core 24 is, similarly to the first inner stator core 23, also a component part which is structured by means of that a rolled steel plate having thickness about 0.15 mm is press-worked in a ring shape. The second inner stator core 24 includes a plurality of pole teeth 240, which are bent upward at positions with an equal angular interval from an inner circumferential edge of a ring-shaped flange part 24a (first end plate part), cut-out parts 245 formed between a plurality of the respective pole teeth 240 (first pole teeth), and two protruded parts 241 (second protruded part) which are protruded in parallel from its outer peripheral edge. These protruded parts 241 respectively include base parts 241a, which are horizontally extended toward the outer side in the radial direction from a ring portion of the second inner stator core 24, bent parts 241b which are bent upward from tip ends of the base parts 241a, and horizontal plate parts 241c which are horizontally extended toward the outer side in the radial direction from the bent parts 241b. The protruded part 241 functions as a circuit board holding part for holding the circuit board 7 for power supply which will be described below.

In this embodiment, in the first inner stator core 23 and the second inner stator core 24, the cut-out parts 235 and 245 are formed between the plurality of the pole teeth 230 and 240 and, on the other hand, in the first outer stator core 21 and the second outer stator core 22, cut-out parts are not formed between the plurality of the pole teeth 210 and 220, and only holes by cut-and-bent of the plurality of the pole teeth 210 and 220 are formed.

As shown in FIG. 4(A), the first drive coil 61 and the second drive coil 62 are a flat-shaped air-core coil (bobbin-less coil), which is formed by means of that a coil wire made of a rectangular wire is wound around by a predetermined number of times in an alpha winding manner. The coil wire is wound around two layers in an axial direction and a number of times in a radial direction. The air-core coil formed in the alpha winding is obtained by means of that, after a middle portion of a coil wire has been wound around an outer peripheral face of a jig that is formed in a cylindrical tube shape or a cylindrical column shape, its one end part is wound around the jig a number of times and the other end part is wound around at an adjacent portion a number of times. The shape of the air-core coil is maintained by using a thermally fusing layer which is coated on the coil wire.

Two coil ends 618 and 619 of the first drive coil 61 correspond to the winding end coils and are drawn out toward the outer side without overlapping on the end face of the first drive coil 61. Further, two coil ends 628 and 629 of the second drive coil 62 also correspond to the winding end coils and are drawn out toward the outer side without overlapping on the end face of the second drive coil 62. Therefore, the first drive coil 61 and the second drive coil 62 are formed thinner by an amount of that there is no winding end coil which is drawn out from an inner periphery to an outer periphery through an end face.

The coil ends 618 and 619 are wound to positions close to each other on the outer peripheral portion of the first drive coil 61 and bent at the close positions to be drawn out parallel toward the outer side in the radial direction. Further, the coil ends 628 and 629 are also wound to positions close to each other on the outer peripheral portion of the second drive coil 62 and bent at the close positions to be drawn out parallel toward the outer side in the radial direction. In other words, when a length dimension of a circuit board 7 for power supply is set to be “S1” the coil ends 618 and 619 and the coil ends 628 and 629 are drawn out from positions separated with a distance “S2” which is shorter than the length dimension “S1” of the circuit board 7 for power supply (see FIG. 3).

In order to structure the stator 2 by superposing the first outer stator core 21, the first drive coil 61, the first inner stator core 23, the second inner stator core 24, the second drive coil 62 and the second outer stator core 22 on each other in the thrust direction which are structured as described above, insulation sheets 65 are superposed on both faces of the first drive coil 61 and insulation sheets 65 are superposed on both faces of the second drive coil 62.

### (Structure of Circuit Board 7 for Power Supply)

In the motor 1 in this embodiment, power supply to the first drive coil 61 and the second drive coil 62 is performed through the common circuit board 7 for power supply which is made of glass-epoxy substrate or phenol substrate. For this purpose, an upper face of the circuit board 7 for power supply (end face on the output side) is formed with land parts 71a and 71b to which the coil ends 628 and 629 of the second drive coil 62 are connected by soldering, land parts 73a and 73b to which a flexible circuit board 9 described below is connected, and wiring pattern parts 72a and 72b for connecting corresponding land parts.

In this embodiment, the coil ends 628 and 629 are drawn out parallel from the close positions to each other of the outer peripheral face of the second drive coil 62. Therefore, the land parts 71a and 71b of the circuit board 7 for power supply to which the coil ends 628 and 629 are connected by soldering are disposed at close positions to each other, and the land parts 73a and 73b which are connected with the flexible circuit board 9 and the wiring pattern parts 72a and 72b are also disposed at close positions to each other in a parallel manner.

The circuit board 7 for power supply is a double-side circuit board and, not shown in the drawing, the under face of the circuit board 7 for power supply (opposite-to-output side end face) is structured similarly to the upper face of the circuit board 7 for power supply. The under face of the circuit board 7 for power supply is formed with land parts to which the coil ends 618 and 619 of the first drive coil 61 are connected by soldering, land parts to which a flexible circuit board is connected, and wiring pattern parts for connecting corresponding land parts.

The coil ends 628 and 629 are drawn out along the upper face of the circuit board 7 for power supply (circuit board face) and the coil ends 618 and 619 are drawn out along the under face of the circuit board 7 for power supply (circuit board face). Therefore, even when a terminal block and the like is not formed by using a resin bobbin in which terminals are formed integrally, coil ends of the first drive coil 61 and the second drive coil 62 can be easily treated by using one piece of double-side circuit board (circuit board 7 for power supply).

In this embodiment, the circuit board 7 for power supply includes a rectangular main body portion 76 on which the land parts 71a and 71b, the wiring pattern parts 72a and 72b, and the land parts 73a and 73b are formed, and rectangular connection parts 77 which are protruded on both sides from side edge parts of the main body portion 76. The connection part 77 is formed smaller than the main body portion 76 and stepped parts 78 are formed between the main body portion 76 and the connection part 77.

### (Structure of Rotor)

A rotor 3 is structured of a round bar-shaped rotation shaft 35, a cup-shaped rotor case 31, and a ring-shaped permanent magnet 32 on which an “S”-pole and an “N”-pole are alternately magnetized in a circumferential direction. The rotor case 31 includes an inner peripheral side cylindrical part 31b to which the rotation shaft 35 is fitted, an outer peripheral side cylindrical part 31c in which the permanent magnet 32 is fixed to its outer peripheral face, and a ring-shaped flat plate part 31a which connects the outer peripheral side cylindrical part 31c with the inner peripheral side cylindrical part 31b. In this embodiment, the rotor case 31 is formed by drawing working (press working) of a flat plate-shaped member, and the inner peripheral side cylindrical part 31b and the outer peripheral side cylindrical part 31c are respectively formed to stand up toward the output side from an inner circumferential edge and an outer circumferential edge of the ring-shaped flat plate part 31a. A dimension in a thrust direction (width dimension) of the permanent magnet 32 is set to be larger than a dimension in the thrust direction (width dimension) of the outer peripheral side cylindrical part 31c, and both end parts in the thrust direction of the permanent magnet 32 are protruded in the thrust direction from the upper end and the bottom end of the outer peripheral side cylindrical part 31c. Therefore, a facing area of the permanent magnet 32 to the stator 2 is wide. A through hole is formed in the inner peripheral side cylindrical part 31b and an opposite-to-output side end part of the rotation shaft 35 is inserted into the through hole.

### (Structure of Bearing)

In this embodiment, an opposite-to-output side bearing 51 which is held by the first outer stator core 21 is made of resin. The opposite-to-output side bearing 51 includes a disk part 51a having a large diameter and a cylindrical part 51b protruding toward the opposite-to-output side from the disk part 51a. A shaft hole 51e which is a through hole is formed at the center of the opposite-to-output side bearing 51 and an opposite-to-output side end part of the rotation shaft 35 is inserted into the shaft hole 51e. The opposite-to-output side bearing 51 structured as described above is fixed to the first outer stator core 21 by means of that the cylindrical part 51b is press-fitted into the through hole 21b of the first outer stator core 21 until the stepped part 51f formed by the disk part 51a and the cylindrical part 51b is positioned by the first outer stator core 21 and fixed to the first outer stator core 21.

The output side bearing 52 which is held by the second outer stator core 22 is made of an oil-impregnated sintered bearing which is structured of a metal sintered body containing lubricating oil, and a large diameter part 52c, a middle diameter part 52b and a small diameter part 52a are formed from the opposite-to-output side to the output side in this order. The large diameter part 52c and the middle diameter part 52b of the output side bearing 52 is formed with a recessed part 52d which opens at an opposite-to-output side end face. A bottom part 52g of the recessed part 52d is formed with a shaft hole 52e which penetrates through the small diameter part 52a and an output side end part of the rotation shaft 35 is inserted into the shaft hole 52e. The output side bearing 52 structured as described above is fixed to the second outer stator core 22 by a method such as caulking in a state that the middle diameter part 52b is fitted into the through hole 22b of the second outer stator core 22 and positioned by a stepped part 52f formed between the middle diameter part 52b and the large diameter part 52c.

### (Manufacturing Method for Motor and Detailed Description of Stator)

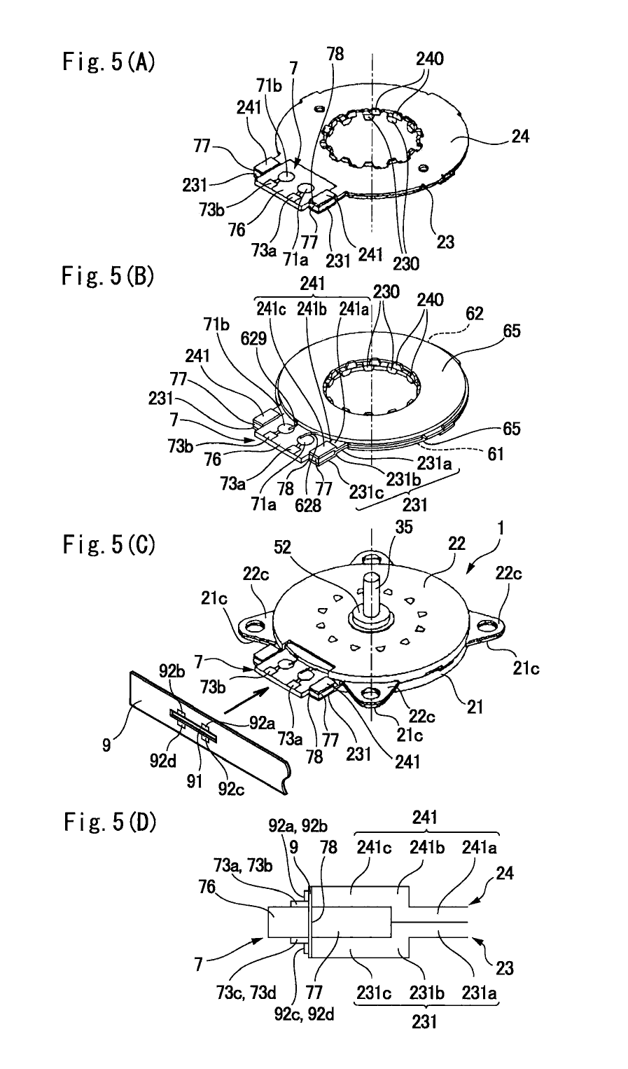

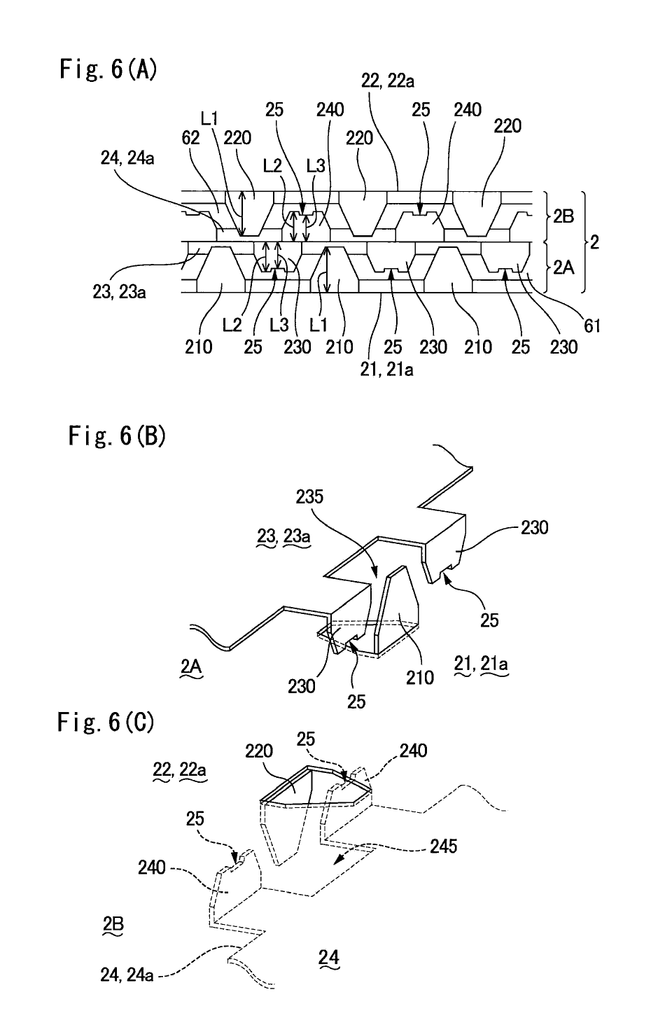

In addition to FIGS. 1 through FIG. 4(B), with reference to FIG. 5(A) through FIG. 6(C), the structure of the motor to which an embodiment of the present invention is applied will be further described while describing a manufacturing method for the motor to which an embodiment of the present invention is applied.

FIGS. 5(A) through 5(D) are explanatory views showing a stator of the motor to which an embodiment of the present invention is applied. FIGS. 6(A), 6(B) and 6(C) are respectively, an enlarged side view showing pole teeth which are provided in a motor to which an embodiment of the present invention is applied, a perspective view schematically showing a structure of pole teeth of an “A”-phase stator, and a perspective view schematically showing a structure of pole teeth of a “B”-phase stator.

In order to manufacture the motor 1 in this embodiment, first, the rotation shaft 35 is fixed to the inner peripheral side cylindrical part 31b of the rotor case 31 described with reference to FIGS. 1 through 3 by a method such as press-fitting and, in addition, the permanent magnet 32 is fixed to the outer peripheral face of the outer peripheral side cylindrical part 31c by a method such as adhesively bonding. In this manner, the rotor 3 has been assembled in advance. Further, the opposite-to-output side bearing 51 is fixed to the through hole 21b of the first outer stator core 21 by a method such as press-fitting and the output side bearing 52 is fixed to the through hole 22b of the second outer stator core 22 by a method such as caulking.

Next, as shown in FIG. 5(A), the first inner stator core 23 and the second inner stator core 24 are superposed and joined with each other so that the pole teeth 230 and 240 are directed on opposite sides to each other. In this case, the two protruded parts 231 of the first inner stator core 23 and the two protruded parts 241 of the second inner stator core 24 are overlapped each other and thus the connection parts 77 formed on both end parts of the circuit board 7 for power supply are sandwiched between the protruded parts 231 and 241. In other words, in the protruded parts 231 and 241, the horizontal plate parts 231c and 241c on their tip end sides are extended from the positions separated from each other through the bent parts 231b and 241b, and a gap space corresponding to a thickness of the circuit board 7 for power supply is formed between the horizontal plate parts 231c and 241c. The connection parts 77 of the circuit board 7 for power supply are held in the gap space. As a result, the circuit board 7 for power supply is held in a substantially perpendicular posture with respect to the motor axial line on the outer peripheral side of the first inner stator core 23 and the second inner stator core 24.

Next, as shown in FIG. 5(B), the first drive coil 61 is superposed on the under face of the first inner stator core 23 through the insulation sheet 65 and the second drive coil 62 is superposed on the upper face of the second inner stator core 24 through the insulation sheet 65. As a result, the coil ends 628 and 629 of the second drive coil 62 are overlapped with the land parts 71a and 71b which are formed on the upper face of the circuit board 7 for power supply and thus the coil ends 628 and 629 are connected to the land parts 71a and 71b of the circuit board 7 for power supply by soldering. Similarly, the coil ends 618 and 619 of the first drive coil 61 are also overlapped with the land parts (not shown) formed on the under face of the circuit board 7 for power supply and thus the coil ends 618 and 619 are connected to the land parts of the circuit board 7 for power supply by soldering.

In accordance with an embodiment of the present invention, as shown in FIG. 4(B), the coil end 629 drawn out from the upper layer of the second drive coil 62 is twisted upside down and extended at a slightly lower position than the drawing position. In this case, only when the second drive coil 62 is superposed on the upper face of the second inner stator core 24, the tip end portions of the coil ends 628 and 629 are superposed on and contacted with the upper face of the circuit board 7 for power supply. Therefore, the coil ends 628 and 629 can be respectively connected to the land parts 71a and 71b of the circuit board 7 for power supply by soldering easily. In accordance with an embodiment of the present invention, it may be structured that both of the coil ends 628 and 629 are twisted upside down and tip end portions of the coil ends 628 and 629 are superposed on and contacted to the upper face of the circuit board 7 for power supply. Alternatively, both of the coil ends 628 and 629 may be twisted to set in a horizontal state to the circuit board 7 for power supply and the coil ends 628 and 629 are respectively connected to the land parts 71a and 71b of the circuit board 7 for power supply by soldering. The coil ends 618 and 619 of the first drive coil 61 may be structured similarly.

Next, the rotor 3 is inserted on an inner side of a laminated body, which is structured of the first drive coil 61, the first inner stator core 23, the second inner stator core 24 and the second drive coil 62 and then, as shown in FIG. 5(C), the first outer stator core 21 is superposed on the under face of the first drive coil 61 through the insulation sheet 65 and the second outer stator core 22 is superposed on the upper face of the second drive coil 62 through the insulation sheet 65. At this time, the opposite-to-output side shaft end of the rotation shaft 35 is inserted into the shaft hole 51e of the opposite-to-output side bearing 51 which is held by the first outer stator core 21, and the output side shaft end of the rotation shaft 35 is inserted into the shaft hole 52e of the output side bearing 52 which is held by the second outer stator core 22. After that, the joining parts 21c and 22c of the first outer stator core 21 and the second outer stator core 22 are joined to each other by a method such as welding or caulking.

When the stator 2 is assembled as described above, the rotor 3 is rotatably held on the inner side of the stator 2. Further, the inner peripheral side cylindrical part 31b of the rotor case 31 is entered into the recessed part 52d of the output side bearing 52 and thus the rotor 3 can be disposed on the inner side of the thin stator 2. In this embodiment, an outer diameter dimension of the rotor case 31 is set to be larger than an outer diameter dimension of the opposite-to-output side bearing 51 and an outer diameter dimension of the output side bearing 52. Therefore, the permanent magnet 32 is disposed on the outer sides in the radial direction of the opposite-to-output side bearing 51 and the output side bearing 52.

In the stator 2 structured as described above, as shown in FIGS. 6(A) and 6(B), an “A”-phase stator assembly 2A is structured of the first outer stator core 21, the first drive coil 61 and the first inner stator core 23 and, in this stator assembly 2A, the pole teeth 210 of the first outer stator core 21 and the pole teeth 230 of the first inner stator core 23 are alternately disposed along the inner peripheral face of the stator 2.

Cut-out parts 235 are formed between the respective pole teeth 230 of the first inner stator core 23, and the cut-out part 235 is formed on a tip end side from which the pole teeth 210 of the first outer stator core 21 are extended. Therefore, although the pole teeth 210 are extended with a long dimension, i.e., a length dimension “L1”, the tip end parts of the pole teeth 210 are located on the inner side of the cut-out parts 235 and thus a sufficient gap space is secured to the first inner stator core 23. Accordingly, leakage flux between the pole teeth 210 and the first inner stator core 23 does not become a problem.

On the other hand, cut-out parts are not formed between the respective pole teeth 210 of the first outer stator core 21 and thus a lower bottom part 21a of the first outer stator core 21 is located on the tip end side of the pole teeth 230 of the first inner stator core 23. In this case, when a distance between the tip end parts of the pole teeth 230 and the lower bottom part 21a of the first outer stator core 21 is narrow, magnetic flux is leaked out from the tip end parts of the pole teeth 230 to the lower bottom part 21a and thus magnetic flux effective for torque between the pole teeth 210 and the pole teeth 230 is reduced by the amount due to the above-mentioned leakage. In this embodiment, both side portions in a widthwise direction of each of the pole teeth 230 are set to have a sufficient length dimension “L2” (L1>L2), and a recessed part 25 is formed at a center portion in the widthwise direction where leakage flux is easily generated so that the center portion in the widthwise direction is shortened to a length dimension “L3” (L1>L2>L3). Accordingly, leakage flux between the pole teeth 230 and the first outer stator core 21 does not become a problem.

Further, in the stator 2, as shown in FIGS. 6(A) and 6(C), the “B”-phase stator assembly 2B is structured of the second outer stator core 22, the second drive coil 62 and the second inner stator core 24 and, in the stator assembly 2B, the pole teeth 220 of the second outer stator core 22 and the pole teeth 240 of the second inner stator core 24 are alternately disposed along the inner peripheral face of stator 2.

Cut-out parts 245 are formed between the respective pole teeth 240 of the second inner stator core 24, and the cut-out part 245 is formed on a tip end side from which the pole teeth 220 of the second outer stator core 22 are extended. Therefore, although the pole teeth 220 are extended with a long dimension, i.e., a length dimension “L1”, the tip end parts of the pole teeth 220 are located on the inner side of the cut-out parts 245 and thus a sufficient gap space is secured to the second inner stator core 24. Accordingly, leakage flux between the pole teeth 220 and the second inner stator core 24 does not become a problem.

On the other hand, cut-out parts are not formed between the respective pole teeth 220 of the second outer stator core 22 and thus an upper bottom part 22a of the second outer stator core 22 is located on the tip end side of the pole teeth 240 of the second inner stator core 24. In this case, when a distance between the tip end parts of the pole teeth 240 and the upper bottom part 22a of the second outer stator core 22 is narrow, magnetic flux is leaked out from the tip end parts of the pole teeth 240 to the upper bottom part 22a and thus magnetic flux effective for torque between the pole teeth 220 and the pole teeth 240 is reduced by the amount due to the above-mentioned leakage. In this embodiment, both side portions in the widthwise direction of each of the pole teeth 240 are set to have a sufficient length dimension “L2” (L1>L2), and a recessed part 25 is formed at a center portion in the widthwise direction where leakage flux is easily generated so that the center portion in the widthwise direction is shortened to a length dimension “L3” (L1>L2>L3). Accordingly, leakage flux between the pole teeth 240 and the second outer stator core 22 does not become a problem.

After a principal portion of the motor 1 has been structured as described above, an end part of the circuit board 7 for power supply is inserted into a slit 91 of a flexible circuit board 9 which is used for connecting with the outside and the flexible circuit board 9 is disposed in a substantially perpendicular posture to the circuit board 7 for power supply. In this embodiment, the circuit board 7 for power supply is formed with the small connection parts 77 on both sides of the main body portion 76 and, in the end part which is located on the outer peripheral side of the circuit board 7 for power supply, end parts which are located on the outer peripheral sides of the connection parts 77 are located at recessed positions from the end part of the main body portion 76. Further, a length dimension of the slit 91 of the flexible circuit board 9 is slightly longer than a length dimension of the main body portion 76 of the circuit board 7 for power supply. Therefore, when the end part of the circuit board 7 for power supply is inserted into the slit 91 of the flexible circuit board 9, rear faces of both side portions of the flexible circuit board 9 sandwiching the slit 91 in the longitudinal direction are abutted with the end parts of the connection parts 77, i.e., the stepped parts 78 to be positioned. Alternatively, the flexible circuit board 9 may be positioned by means of that the rear face of the flexible circuit board 9 is abutted with tip end parts of the protruded parts 231 and 241.

The flexible circuit board 9 is formed with four land parts 92a, 92b, 92c and 92d in total on both side positions interposing the slit 91, and wiring circuit patterns (not shown) are extended from the land parts 92a, 92b, 92c and 92d. Further, as shown in FIG. 5(D), in the state that the end part of the circuit board 7 for power supply is inserted into the slit 91 of the flexible circuit board 9, a portion where the land parts 73a and 73b are formed of the main body portion 76 of the circuit board 7 for power supply is passed through the slit 91 of the flexible circuit board 9 to be protruded on the outer peripheral side. In this state, on the outer side of the flexible circuit board 9, the land parts 92a and 92b of the flexible circuit board 9 are overlapped with the land parts 73a and 73b which are formed on an upper face of the circuit board 7 for power supply, and the land parts 92c and 92d of the flexible circuit board 9 are overlapped with the land parts 73c and 73d which are formed on an under face of the circuit board 7 for power supply. Therefore, on the outer side of the flexible circuit board 9, when the land parts 92a and 92b of the flexible circuit board 9 are connected by soldering with the land parts 73a and 73b which are formed on the upper face of the circuit board 7 for power supply and, when the land parts 92c and 92d of the flexible circuit board 9 are connected by soldering with the land parts 73c and 73d which are formed on the under face of the circuit board 7 for power supply, the motor 1 is completed. Accordingly, even when an expensive double-side circuit board is not used as the flexible circuit board 9, the flexible circuit board 9 can be connected with the land parts 73a, 73b, 73c and 73d which are formed on the circuit board 7 for power supply.

### (Operation and Detailed Description of Bearing Structure)

The bearing structure for the rotor 3 will be described with reference to FIG. 2 while describing an operation of the motor 1 in this embodiment. In the motor 1 in this embodiment, an electrical power is supplied to the first drive coil 61 and the second drive coil 62 through the flexible circuit board 9 and the circuit board 7 for power supply, the rotor 3 is rotated.

In this case, an inner peripheral face of the shaft hole 51e of the opposite-to-output side bearing 51 functions as a radial support part 51x which supports the outer peripheral face of the rotation shaft 35, and an upper end face of the disk part 51a of the opposite-to-output side bearing 51, which is located on the output side bearing 52 side, functions as a thrust support part 51y which supports an under face of the ring-shaped flat plate part 31a of the rotor case 31 in a thrust direction (face on the opposite-to-output side of the ring-shaped flat plate part 31a, or a portion except a shaft end of the rotation shaft 35 of the rotor 3). In this embodiment, the rotor 3 is rotated by a magnetic attractive force generated between the permanent magnet 32 and the stator 2 in a state that the thrust support part 51y of the opposite-to-output side bearing 51 (upper end face of the disk part 51a) is contacted with the under face of the ring-shaped flat plate part 31a of the rotor case 31 and thus the thrust support part 51y of the opposite-to-output side bearing 51 and the under face of the ring-shaped flat plate part 31a of the rotor case 31 are slid on each other.

Further, an inner peripheral face of the shaft hole 52e of the output side bearing 52 functions as a radial support part 52x which supports an outer peripheral face of the rotation shaft 35. Further, a lower side end face of the large diameter part 52c of the output side bearing 52, which is located on the opposite-to-output side bearing 51 side, functions as a stopper part 52y which faces an upper face of the ring-shaped flat plate part 31a of the rotor case 31 (output side face of the ring-shaped flat plate part 31a or a portion except the shaft end of the rotation shaft 35 of the rotor 3) in the thrust direction through a predetermined gap space “d1” so as to be capable of limiting a moving range in the thrust direction of the rotor 3. In other words, the spaced distance “d1” in the thrust direction between the lower side end face of the large diameter part 52c and the ring-shaped flat plate part 31a is shorter than the spaced distance “d2” with respect to the tip end part of the inner peripheral side cylindrical part 31b of the rotor 3. Therefore, even when an impact is applied from the outside to displace the rotor 3 in the thrust direction, the lower side end face of the large diameter part 52c is abutted with the upper face of the ring-shaped flat plate part 31a of the rotor case 31 as the stopper part 52y to prevent the rotor 3 from excessively being displaced in the thrust direction.

(Principal Effects in this Embodiment)

As described above, in the motor 1 in this embodiment, the coil ends 618, 619, 628 and 629 are treated on the circuit board 7 for power supply, which is sandwiched between the protruded part 231 of the first inner stator core 23 and the protruded part 241 of the second inner stator core 24 in a substantially perpendicular posture with respect to the motor axial line (thrust direction). Therefore, it is not required that the terminal block is provided and terminal pins for treating the coil ends are fixed to the terminal block and thus a height or a width of the motor 1 can be reduced. Further, the circuit board 7 for power supply is sandwiched between the protruded part 231 of the first inner stator core 23 and the protruded part 241 of the second inner stator core 24 and thus the circuit board 7 for power supply can be held securely. Moreover, since the protruded parts 231 and 241 sandwich both end parts of the circuit board 7 for power supply, the circuit board 7 for power supply can be held with a sufficient strength.

Further, since a member for holding the circuit board 7 for power supply is not required to provide separately, the structure of the motor 1 can be simplified. Especially, in this embodiment, the circuit board 7 for power supply is held by the protruded parts 231 and 241 arranged in the inner stator cores 23 and 24 of the stator 2. Therefore, a circuit board holding part can be formed easily only by partly modifying a molding die for manufacturing the inner stator cores 23 and 24 by press working or the like.

In addition, the circuit board 7 for power supply is located between the “A”-phase stator assembly 2A and the “B”-phase stator assembly 2B and the circuit board 7 for power supply is a double-side circuit board. Therefore, it is convenient for treating both coil ends of the first drive coil 61 and the second drive coil 62.

In addition, positioning of the flexible circuit board 9 is performed by means of that the rear face of the flexible circuit board 9 which is disposed in a substantially perpendicular manner with respect to the circuit board 7 for power supply is abutted with the connection part 77 of circuit board 7 for power supply. Therefore, the flexible circuit board 9 is surely disposed at the predetermined position with respect to the circuit board 7 for power supply. Accordingly, electric connection between the circuit board 7 for power supply and the flexible circuit board 9 is easily and securely performed. Further, in the state that the flexible circuit board 9 is fitted to the circuit board 7 for power supply, the portions of the main body portion 76 of the circuit board 7 for power supply on which the land parts 73a and 73b are formed are protruded on the outer peripheral side through the slit 91 of the flexible circuit board 9. Therefore, electric connection between the circuit board 7 for power supply and the flexible circuit board 9 is performed on an outer side of the flexible circuit board 9 and thus connecting work is easy.

Further, in the motor 1 in this embodiment, an air-core coil formed in a flat shape, which is formed by means of that a coil wire comprised of a rectangular wire is wound around a predetermined number of times by alpha winding, is used as the first drive coil 61 and the second drive coil 62. All of coil ends 618, 619, 628 and 629 are drawn out on an outer side without overlapping an coil end face. Therefore, both of the first drive coil 61 and the second drive coil 62 are thin. Further, since the coil ends 618, 619, 628 and 629 do not overlap the coil end face, when the drive coils 61 and 62 are to be mounted on the motor 1, an unfavorable force is not applied to the drive coils 61 and 62 or the coil ends 618, 619, 628 and 629 and thus disconnection does not occur and a member for preventing disconnection is not required. Accordingly, the structure of the motor 1 can be simplified and the motor 1 can be made thinner.

In addition, the coil ends 618, 619, 628 and 629 are drawn out from the positions of the outer peripheral portions of the drive coils 61 and 62 which are separated by a distance shorter than the length dimension of the circuit board 7 for power supply. Therefore, even when the coil ends 618, 619, 628 and 629 are not drawn and passed through, the coil ends 618, 619, 628 and 629 are guided on the circuit board face of the circuit board 7 for power supply. Further, the coil ends 618, 619, 628 and 629 are extended along the circuit board faces (upper face and under face) of the circuit board 7 for power supply. Besides, when the coil ends 618, 619, 628 and 629 are twisted, all of the coil ends 618, 619, 628 and 629 can be extended so as to contact with the circuit board faces (upper face and under face) of the circuit board 7 for power supply. Accordingly, connecting work of the coil ends 618, 619, 628 and 629 with the circuit board 7 for power supply can be easily and efficiently performed by using solder.

In addition, the first outer stator core 21 and the second outer stator core 22 are respectively used as a lower case and an upper case, and the opposite-to-output side bearing 51 and the output side bearing 52 are held by the first outer stator core 21 and the second outer stator core 22. Therefore, a case and an end plate which are separately structured from the first outer stator core 21 and the second outer stator core 22 are not required, the motor 1 can be made thinner.

In this embodiment, when the first outer stator core 21 and the second outer stator core 22 are respectively used as a lower case and an upper case and, when the opposite-to-output side bearing 51 and the output side bearing 52 are held by the first outer stator core 21 and the second outer stator core 22, the lower bottom part 21a and the upper bottom part 22a are required to form on the inner side of the portion where the pole teeth 210 and 220 are cut and bent in the first outer stator core 21 and the second outer stator core 22. Therefore, the cut-out part is not formed between the pole teeth 210 and 220. Accordingly, the pole teeth 230 of the first inner stator core 23 and the pole teeth 240 of the second inner stator core 24 are formed to extend toward the lower bottom part 21a of the first outer stator core 21 and toward the upper bottom part 22a of the second outer stator core 22 and thus leakage flux may become larger. However, in this embodiment, the recessed part 25 is formed only at the center portion in the widthwise direction of the pole teeth 230 and 240 and thus leakage flux can be restrained. Accordingly, the magnetic flux flowing between the adjacent pole teeth 210 and 230 and between the adjacent pole teeth 220 and 240 is increased by the amount of flux which is prevented from leaking from the tip end parts of the pole teeth 230 and 240 and thus a large torque can be obtained.

Further, in the motor 1 in this embodiment, the opposite-to-output side bearing 51 is provided with the radial support part 51x (inner peripheral face of the shaft hole 51e) which supports the outer peripheral face of the rotation shaft 35 and the thrust support part 51y (upper side end face of the disk part 51a) which supports the under face of the ring-shaped flat plate part 31a of the rotor case 31 (portion except the shaft end of the rotation shaft 35 of the rotor 3) in the thrust direction. In other words, the opposite-to-output side bearing 51 is provided with both of the function for supporting the rotor 3 in the radial direction and the function for supporting the rotor 3 in the thrust direction by using only one piece of bearing. Further, the radial support part 51x supports the outer peripheral face of the rotation shaft 35 and the thrust support part 51y supports the portion of the rotor 3 except the shaft end of the rotation shaft 35. Therefore, both of the radial support part 51x and the thrust support part 51y are not required to dispose on the outer side of the shaft end of the rotation shaft 35 in the thrust direction. As a result, according to this embodiment, the number of part items are reduced and the size and the width of the motor 1 can be reduced.

Further, the output side bearing 52 is provided with the radial support part 52x (inner peripheral face of the shaft hole 52e) which supports the outer peripheral face of the rotation shaft 35 and the stopper part 52y (lower side end face of the large diameter part 52c) which faces the upper face of the ring-shaped flat plate part 31a of the rotor case 31 (portion of the rotor 3 except the shaft end of the rotation shaft 35) through a predetermined gap space in the thrust direction so as to be capable of determining the moving range in the thrust direction of the rotor 3. In other words, the output side bearing 52 is provided with the function for supporting in the radial direction and the function for preventing an excessive movement of the rotor 3 in the thrust direction by using only one piece of bearing. Further, the radial support part 52x supports the outer peripheral face of the rotation shaft 35 and the stopper part 52y faces the portion of the rotor 3 except the shaft end of rotation shaft 35. Therefore, both of the radial support part 52x and the stopper part 52y are not required to be disposed on the outer side of the shaft end of the rotation shaft 35 in the thrust direction. As a result, according to this embodiment, the number of part items are reduced and the size and the width of the motor 1 can be reduced.

Further, the sliding portion of the rotor 3 on the thrust support part 51y of the opposite-to-output side bearing 51 is the ring-shaped flat plate part 31a. Therefore, since the sliding portion of the rotor 3 on the opposite-to-output side bearing 51 is in a face-contact state, abrasion hardly occurs and thus the lifetime of the motor 1 can be extended. Further, even when the stopper part 52y is abutted with the rotating rotor 3, an excessive impact is not applied to the output side bearing 52 and the rotor 3, which is different from a structure in which the stopper part 52y is abutted with the tip end part of the inner peripheral side cylindrical part 31b or the tip end part of the outer peripheral side cylindrical part 31c. Therefore, damage and abrasion does not occur in the output side bearing 52 and the rotor 3 and thus the lifetime of the motor 1 can be extended. In addition, when the rotor case 31 is formed by drawing working, although a high productivity is obtained, a burr is easily formed at the tip end part of the inner peripheral side cylindrical part 31b. However, since the portion other than the inner peripheral side cylindrical part 31b is set to be the abutting part with the stopper part 52y, even when a burr is formed at the tip end part of inner peripheral side cylindrical part 31b, the output side bearing 52 is not caught by the rotor 3.

In addition, the permanent magnet 32 is disposed on the outer side in the radial direction of both of the opposite-to-output side bearing 51 and the output side bearing 52. Therefore, even when the opposite-to-output side bearing 51 and the output side bearing 52 are protruded on the inner side in the thrust direction, a large magnet in the thrust direction (width dimension) may be used for the permanent magnet 32. Accordingly, even when the motor 1 is made thinner, a large output can be obtained.

As described above, in this embodiment, the main body portion of the motor 1 (portion except the rotation shaft 35) can be made thinner, for example, in about 1.9 mm and, even when the motor 1 is made thinner, a sufficient torque can be obtained.

### OTHER EMBODIMENTS

In the embodiment described above, the opposite-to-output side bearing 51 is provided with the radial support part and the thrust support part to structure the first bearing and the output side bearing 52 is provided with the radial support part and the stopper part to structure the second bearing. However, the radial support part and the stopper part are provided in the opposite-to-output side bearing to structure the second bearing and the radial support part and the thrust support part are provided in the output side bearing to structure the first bearing. Further, the radial support part and the thrust support part may be provided in both of the opposite-to-output side bearing and the output side bearing.

Further, in the embodiment described above, a double-side circuit board is used for the circuit board 7 for power supply but a single-side circuit board may be used and the coil ends 618, 619, 628 and 629 are drawn out on the same face of the circuit board 7 for power supply to be connected with the circuit board 7.

Further, in the embodiment described above, the first outer stator core 21 and the second outer stator core 22 are used for the lower case and the upper case, and the first outer stator core 21 and the second outer stator core 22 hold the opposite-to-output side bearing 51 and the output side bearing 52 and, as a result, the lower bottom part 21a and the upper bottom part 22a are formed on the inner sides of the portions where the pole teeth 210, 220 are cut and bent. However, on the basis of other reasons, an embodiment of the present invention may be applied to a case that the first pole teeth formed in one of the stator cores are disposed closer to the end plate part of the other of the stator cores.

Further, facing areas to the permanent magnet 32 of the adjacent pole teeth 210 and 230 and the adjacent pole teeth 220 and 240 may be structured so as to be substantially equal to each other. According to this structure, the magnetic flux flowing between the rotor magnet and the pole teeth can be maintained in an appropriate state.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A motor comprising:
a rotor provided with a permanent magnet; and
a stator which is provided with stator cores and a drive coil and which is disposed on an outer peripheral side of the rotor;
wherein the stator is provided with a circuit board holding part for holding a circuit board for power supply in a posture which is substantially perpendicular to an axial line direction of the motor, and the circuit board for power supply is formed with land parts with which coil ends of the drive coil are connected.

2. The motor according to claim 1, wherein
the stator includes an “A”-phase stator assembly and a “B”-phase stator assembly which are superposed on each other in a thrust direction and disposed around the rotor,
each of the “A”-phase stator assembly and the “B”-phase stator assembly is provided as the stator core with an inner stator core and an outer stator core on both sides in the thrust direction of the drive coil, and the inner stator cores are superposed on each other in the thrust direction, and
the circuit board holding part includes a first protruded part which is protruded on an outer side in a radial direction from the inner stator core of the “A”-phase stator assembly and a second protruded part which is protruded on an outer side in the radial direction from the inner stator core of the “B”-phase stator assembly so that the circuit board for power supply is held between the first protruded part and the second protruded part.

3. The motor according to claim 2, wherein
the circuit board for power supply is provided, as the land part, with a land part formed on one side face of the circuit board for power supply for being connected with a coil end of a drive coil of the “A”-phase stator assembly, and with a land part formed on an other side face of the circuit board for power supply for being connected with a coil end of a drive coil of the “B”-phase stator assembly.

4. The motor according to claim 2, wherein
each of the first protruded part and the second protruded part comprises at least two protruded parts so as to be capable of holding both end portions of the circuit board for power supply.

5. The motor according to claim 2, wherein
the first protruded part includes a base part which is horizontally extended on the outer side in the radial direction from a ring portion of the inner stator core of the “A”-phase stator assembly, a bent part which is bent downward from a tip end of the base part, and a horizontal plate part which is horizontally extended on the outer side in radial direction from the bent part, and
the second protruded part includes a base part which is horizontally extended on the outer side in the radial direction from a ring portion of the inner stator core of the “B”-phase stator assembly, a bent part which is bent upward from a tip end of the base part, and a horizontal plate part which is horizontally extended on the outer side in the radial direction from the bent part.

6. The motor according to claim 4, wherein
the circuit board for power supply includes a main body portion on which the land part is formed and connection parts which are protruded from both end portions of the main body part for being held by the first protruded part and the second protruded part,
the circuit board for power supply is connected with a flexible circuit board which is disposed substantially perpendicular to the circuit board for power supply, and
a rear face of the flexible circuit board is positioned by abutting with the connection part, the first protruded part or the second protruded part.

7. The motor according to claim 6, wherein
an end part on an outer peripheral side of the connection part of the circuit board for power supply is located on an inner side with respect to an end part on an outer peripheral side of the main body part, and
a portion of the main body portion which is protruded toward an outer peripheral side from the flexible circuit board is electrically connected with the flexible circuit board.

8. A motor comprising:
a rotor provided with a rotation shaft and a permanent magnet;
a stator which is disposed on an outer peripheral side so as to face the permanent magnet;
a first bearing which is fixed to one end face of the stator for rotatably supporting the rotation shaft; and
a second bearing which is fixed to an other end face of the stator for rotatably supporting the rotation shaft;
wherein the first bearing and the second bearing are provided with a radial support part for supporting an outer peripheral face of the rotation shaft, and at least one of the first bearing and the second bearing is provided with a thrust support part for supporting the rotor in a thrust direction on an inner side where an other of the first bearing and the second bearing is located.

9. The motor according to claim 8, wherein
the stator includes an “A”-phase stator assembly and a “B”-phase stator assembly which are superposed on each other in the thrust direction and disposed around the rotor, and
each of the “A”-phase stator assembly and the “B”-phase stator assembly is provided as the stator core with an inner stator core and an outer stator core on both sides in the thrust direction of a drive coil, and the inner stator cores are superposed on each other in the thrust direction.

10. The motor according to claim 9, wherein
the first bearing is provided with the radial support part and the thrust support part, and
the second bearing is provided with the radial support part and a stopper part which is formed on an inner face side where the first bearing is located, and which is capable of determining a moving range in the thrust direction of the rotor through a predetermined gap space in the thrust direction.

11. The motor according to claim 10, wherein
the rotor is structured so that the permanent magnet is integrated with the rotation shaft through a rotor case,
the thrust support part is contacted with the rotor case in the thrust direction, and
the stopper part faces the rotor case through the predetermined gap space in the thrust direction.

12. The motor according to claim 11, wherein
the rotor case includes an inner peripheral side cylindrical part into which the rotation shaft is fitted, an outer peripheral side cylindrical part whose outer peripheral face is fixed to the permanent magnet, and a ring-shaped flat plate part which connects the inner peripheral side cylindrical part with the outer peripheral side cylindrical part,
the thrust support part is contacted with the ring-shaped flat plate part in the thrust direction, and
the stopper part faces the ring-shaped flat plate part through the predetermined gap space in the thrust direction.

13. The motor according to claim 8, wherein
the permanent magnet is disposed on an outer side in a radial direction with respect to both of the first bearing and the second bearing.

14. A motor comprising:
a rotor provided with a permanent magnet; and
a stator which is provided with stator cores and a drive coil and which is disposed on an outer peripheral side of the rotor;
wherein the drive coil is a coil which is structured by means of that a coil wire is wound around in an alpha winding manner and in which a pair of coil ends is located at an outer peripheral portion, and the pair of the coil ends is connected with a circuit board for power supply.

15. The motor according to claim 14, wherein the circuit board for power supply is disposed on a side of the stator so as to be substantially perpendicular to an axial line direction of the motor.

16. The motor according to claim 15, wherein
the pair of the coil ends is wound around to a near position where the pair of the coil ends is separated from each other with a distance shorter than a length dimension of the circuit board for power supply at an outer peripheral portion of the drive coil, and
the pair of the coil ends is bent at the near position to be drawn out toward an outer side in a radial direction.

17. The motor according to claim 14, wherein the pair of the coil ends is extended along a circuit board face of the circuit board for power supply.

18. The motor according to in claim 17, wherein the pair of the coil ends is extended from the drive coil so as to contact with the circuit board face of the circuit board for power supply.

19. The motor according to claim 14, wherein
the stator core comprises an inner stator core and an outer stator core which are disposed on both sides in a thrust direction of the drive coil, and
the drive coil is provided with insulation sheets on both sides in the thrust direction.

20. The motor according to claim 14, wherein
the stator includes an “A”-phase stator assembly and a “B”-phase stator assembly which are superposed on each other in a thrust direction,
each of the “A”-phase stator assembly and the “B”-phase stator assembly is provided as the stator core with an inner stator core and an outer stator core on both sides in the thrust direction of the drive coil, and the inner stator cores are superposed on each other in the thrust direction, and
both of coil ends drawn out from the drive coil of the “A”-phase stator assembly and coil ends drawn out from the drive coil of the “B”-phase stator assembly are connected to the circuit board for power supply which is used in common.

21. The motor according to claim 20, wherein
one face side of the circuit board for power supply is provided with a land part with which the coil end of the drive coil of the “A”-phase stator assembly is connected, and
an other face side of the circuit board for power supply is provided with a land part with which the coil end of the drive coil of the “B”-phase stator assembly is connected.

22. The motor according to claim 20, wherein
each of the drive coil of the “A”-phase stator assembly and the “B”-phase stator assembly is provided with insulation sheets on both sides in the thrust direction, and
the insulation sheets are disposed so as to be superposed on the inner stator core and the outer stator core of the respective stator cores of the “A”-phase stator assembly and the “B”-phase stator assembly.

23. A motor comprising:
a rotor provided with a permanent magnet; and
a stator which is disposed on an outer peripheral side of the rotor;
wherein the stator includes a pair of stator cores which is disposed so as to face each other, and first pole teeth which are protruded from a first end plate part of one of the stator cores and second pole teeth which are protruded from a second end plate part of an other of the stator cores are alternately disposed in a circumferential direction, and
wherein a pole tooth of the first pole teeth is formed with a recessed part at a center position in a widthwise direction of a tip end part of the pole tooth.

24. The motor according to claim 23, wherein lengths of the first pole teeth are shorter than lengths of the second pole teeth.

25. The motor according to claim 23, wherein the one of the stator cores is formed with a cut-out part between the first pole teeth, and the second end plate part of the other of the stator cores is formed between the second pole teeth.

26. The motor according to claim 25, wherein tip end parts of the second pole teeth are located in the cut-out parts of the one of the stator cores, and tip end parts of the first pole teeth face the second end plate part in a thrust direction.

27. The motor according to claim 23, wherein
the stator includes an “A”-phase stator assembly and a “B”-phase stator assembly which are superposed on each other in the thrust direction, and
each of the “A”-phase stator assembly and the “B”-phase stator assembly is provided as the stator core with an inner stator core and an outer stator core on both sides in the thrust direction of the drive coil, and the inner stator cores are superposed on each other in the thrust direction.

28. The motor according to claim 27, wherein
the first pole teeth are formed in each of the inner stator cores of the “A”-phase stator assembly and the “B”-phase stator assembly, and
the second pole teeth are formed in each of the outer stator cores of the “A”-phase stator assembly and the “B”-phase stator assembly.

29. The motor according to claim 4, wherein
the circuit board for power supply is provided, as the land part, with a land part formed on one side face of the circuit board for power supply for being connected with a coil end of a drive coil of the “A”-phase stator assembly, and with a land part formed on an other side face of the circuit board for power supply for being connected with a coil end of a drive coil of the “B”-phase stator assembly.

30. The motor according to claim 13, wherein
the rotor is structured so that the permanent magnet is integrated with the rotation shaft through a rotor case,
the first bearing is provided with the radial support part and the thrust support part, and the thrust support part is contacted with the rotor case in the thrust direction, and
the second bearing is provided with the radial support part and a stopper part which is capable of determining a moving range in the thrust direction of the rotor through a predetermined gap space in the thrust direction, and the stopper part faces the rotor case through the predetermined gap space in the thrust direction.

31. The motor according to claim 19, wherein
the circuit board for power supply is disposed on a side of the stator so as to be substantially perpendicular state to an axial line direction of the motor,
the pair of the coil ends is wound around to a near position where the pair of the coil ends is separated from each other with a distance shorter than a length dimension of the circuit board for power supply at an outer peripheral portion of the drive coil, and the pair of the coil ends is bent at the near position to be drawn out toward an outer side in a radial direction.

32. The motor according to claim 21, wherein
the circuit board for power supply is disposed on a side of the stator so as to be substantially perpendicular state to an axial line direction of the motor,
the pair of the coil ends is wound around to a near position where the pair of the coil ends is separated from each other with a distance shorter than a length dimension of the circuit board for power supply at an outer peripheral portion of the drive coil, and the pair of the coil ends is bent at the near position to be drawn out toward an outer side in a radial direction.

33. The motor according to claim 27, wherein
lengths of the first pole teeth are shorter than lengths of the second pole teeth, and
the inner stator core is formed with a cut-out part between the first pole teeth, and the second end plate part is formed between the second pole teeth of the outer stator core.
